(19) United States
(12) Patent Application Publication
(10) Pub. No.: US 2016/0131168 A1
(43) Pub. Date: May 12, 2016

(54) Mechanical Connection for Profiles, with Cradles Comprising Several Layers of Materials

(71) Applicant: Eric COURTIN, Neuilly sur Seine (FR)

(72) Inventor: Eric Courtin, Neuilly-sur-Seine (FR)

(21) Appl. No.: 14/896,609

(22) PCT Filed: Nov. 8, 2013
(86) PCT No.: PCT/FR2013/052687

§ 371 Date: Dec. 7, 2015

(30) Foreign Application Priority Data
Jun. 7, 2013 (FR) 1355300

(51) Int. Cl. F16B 7/04

(52) U.S. Cl. CPC F16B 7/0486

(57) ABSTRACT

A fixed mechanical connection part, intended to fixedly mechanically connect a first profile and a second profile, that comprises a first cradle, a second cradle, a fixed link between the cradles, is overall rigid, is such that the first wall, the second wall of the first cradle, of the second cradle is composite and comprises, superposed in a united whole an outer layer shaped part having a high rigidity and a high resistance comparable to that of a rigid and resistant steel, limited on one side by an outer free face and from the other side by a rigidly uniting interface with an inner layer shaped part and said inner layer shaped part limited on one side by a rigidly uniting interface with the rigidly uniting interface of the outer layer and from the other side by an inner side forming free face of the first cradle, of the second cradle, in thermoplastic polyurethane or similar, having a good resistance and some elastic flexibility, such that by means of an application force, the free face of the inner layer of the inner side of the cradle is applied intimately on the outer side of the profile, in the manner of a suction cup, and in that way participating in the fixed connection of the fixed mechanical connection part and the profile.

The invention relates to the domain of fixed mechanical connections for rigid profiles such as those suited and intended for making modular bearing structures suited and intended for making functional sets with implementation of “Lean Manufacturing”.

More precisely, the subject matter of the invention is first a fixed mechanical connection part as general means for any specific part or set in order to provide a fixed mechanical connection of profiles, and of any fixed mechanical assembly resulting therefrom.

The term “part” from the expression “fixed mechanical connection part” must be understood as designating a single element which is suited and intended either as is or by means of its combination with one or more elements, to perform the function and provide the intended result, specifically a fixed mechanical connection.

The term “set” from the expression “fixed mechanical connection set” must be understood as designating a whole complete and entire in itself, suited and intended, as is, to perform the function and provide the intended result, specifically a fixed mechanical connection. Thus in some cases, a fixed mechanical connection set may constitute only a single fixed mechanical connection part or comprise several fixed mechanical connection parts.

The term “assembly” must be understood as designating the whole which includes the profiles in consideration and the part or parts and/or the fixed mechanical connection set or sets providing a fixed mechanical connection of the profiles to each other by the outer side thereof.

The subject matter to the invention is next, in a first embodiment, a specific fixed mechanical connection part (conventionally named “subordinate fixed mechanical connection part”) intended to be combined with another analogous connection part, wherein the two parts make up part of a fixed mechanical connection set intended for an assembly in which, for the fixed mechanical connection, there is intimate, firm and continuing application, and use of a means of tightening, of the connection set on the outer side the profiles.

The subject of the invention is also, in a second embodiment, another specific fixed mechanical connection part (conventionally named “autonomous fixed mechanical connection part”) intended for an assembly in which, for a fixed mechanical connection, there is intimate, firm and continuing application by the weight of one element on another underlying element.

The subject matter of the invention is also a modular bearing structure, comprising a plurality of profiles and one or more fixed mechanical connection parts and or one or more fixed mechanical connection sets, arranged in order to provide a fixed mechanical connection of the profiles with each other by the outer sides thereof.

The subject matter of the invention is also a functional set comprising such a modular bearing structure and one or more specific additional functional devices combined with the bearing structure.

Finally the subject matter the invention is the use of a composite wall in order to form such fixed mechanical connection parts.

The expression “fixed mechanical connection” applied to two profiles must be understood as meaning that the two profiles are connected and joined to each other mechanically by one or more fixed mechanical connection parts (in particular subordinate or autonomous) and/or one or more fixed mechanical connection sets, so as to be rigidly united, where the assembly thus made is deformation resistant.

The qualifiers “rigid”, “fixed”, “deformation resistant”, “solid” and “united” must be understood with reference to a context corresponding to the normal conditions of use.

Typically, the two profiles are arranged relative to each other either transversely—at a right angle or inclined—or in parallel—coaxial in line with each other or transversely separated from each other—or side-by-side at some angle.

The term “profile” must be understood, unless otherwise stated, as meaning both an open profile—for example having a transverse section which is U-shaped or pseudo-U-shaped or comprising a U-shape—and also a laterally peripherally closed profile, like a tube, or in another embodiment allowing a peripheral application of a fixed mechanical connection part.

A modular bearing structure such as defined is rigid and suited and intended to making functional sets with implementation of Lean Manufacturing. Such a modular bearing structure resembles overall a solid, skeleton frame formed from profiles and/or fixed mechanical connection sets joining the profiles to each other and providing the fixed connection thereof to each other by the outer side thereof. The shape thereof is suited and intended to the function of the functional set to which it belongs, and for this purpose it is suited and intended to be combined with one or more specific additional functional devices such as receptacles, rails, rollers, stops, sliders, wheels, means of driving or moving, etc., where this list is nonlimiting.

Such functional sets are varied according to their function, results that they seek to obtain, the execution, the size, the consumables or utilities for which they are intended, etc., and ultimately, the process that they seek to implement. Depending on the needs, such functional sets can be suited and intended to be fixed or moved. They can also be suited and intended to a static or dynamic operation.

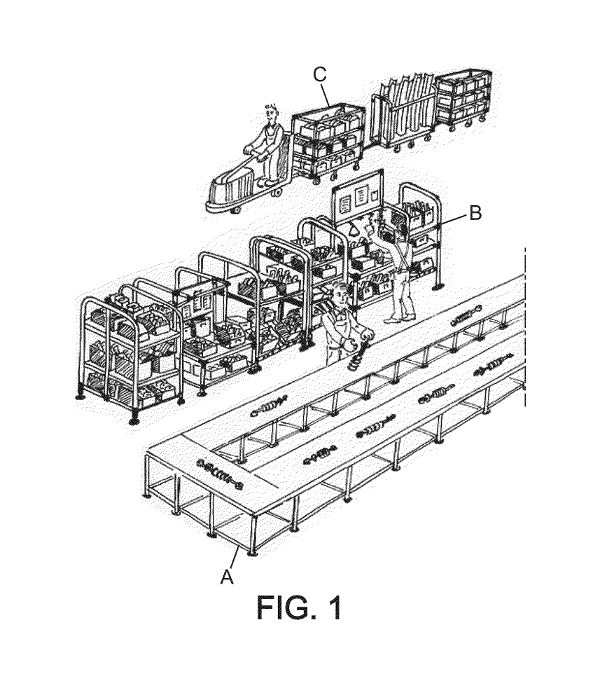

FIG. 1 shows a arrangement of such known functional sets where staff are at work near a worktable resting on a base A, near which are located various shelves B holding containers and a truck C pulling carts.

The term “consumable” must be understood in the most general meaning thereof as signifying an elementary or complex part—including subset or set—of an object, product, device, mechanism, equipment, machine, etc. used in connection with the process considered with the adequate functional set. For its part, the term “utility” must be understood as meaning tool, tool part, subset and set used in the context of a process for accomplishment thereof.

Such functional sets are for example shelving (the term “shelving” needing to be understood in the most general meaning thereof) for holding, moving, supplying, lifting, presenting, etc., bases (for example for a worksurface), sideboards, devices for conveying, guiding and picking, devices for unloading, carts, wagons, work positions etc., where this list is nonlimiting.

The functional sets comprising the modular bearing structures which are being considered are intended for industrial production or logistic or even distribution processes, where this list is nonlimiting. For example, they can be used in the automobile, rail, space, electronics, pharmaceutical and medical industry, and the production of consumer products, luxury products, for packaging, in the bulk distribution sector, etc.

Such functional sets are intended to be placed in workshops, manufacturing units, logistic or distribution centers, etc., where this list is nonlimiting; they are used by the staff who are placed or move nearby and must frequently access them and could even be accessed by the public or clients. For these reasons, it is important today that such functional sets have an appearance which is, if not aesthetic, at least not unsightly. It also matters that in so far as possible they be free of dirt traps and projections which could catch. Additionally, such functional sets must be able to be adapted according to the needs for flexibility of the processes implemented, which assumes easy and secure assembly thereof, ease of disassembly thereof and the reuse of the constituent elements thereof.

Such is the domain of the invention.

The requirements needed for such functional sets and, consequently for such modular bearing structures, along with the constituent profiles, parts and/or fixed mechanical connection sets thereof, are especially solidity, usefulness for multiple purposes (which includes simultaneously the possibility of using the profiles, parts and fixed mechanical connection sets differently, ease of disassembly and reuse), durability (and not breaking down) over time and in an aggressive or difficult environment, the ease of assembly, light weight for transport and of course cost, all other things being equal.

The French patent FR 2,779,782 describes a connection element of the type according to the first embodiment previously identified, intended to be attached to another similar connection element in order to form a connection part itself intended to be combined, with a means of tightening, with tubes having an outside thermoplastic coating, so as to form an adjustable tubular structure. The connection elements comprise extended grooves for tightening intended to engage with the thermoplastic coating of the tubes. But it has been observed that these grooves do not allow an effective attachment of the tubes to the connection parts. According to an improvement which is the subject matter of the patent EP 1,795,766, it is intended to provide the connection elements not with grooves, as before, but with projections arranged for biting pointwise into the thermoplastic coating so as to assure in that way an anchoring of the connection elements onto the tubes. The patent EP 2,123,919 also relates to connection elements of the same type as those previously described and bears on an improvement relating to the means for tightening two connection elements face-to-face.

The connection devices according to the patents FR 2,779,782 and EP 1,795,766 previously cited are known for having been manufactured and sold by TRILOGIQ. In the corresponding embodiments, the tubes have been offered with an outer diameter of 28.6 mm and two thicknesses: 1 mm for light applications and 2 mm for hardened applications. The tubes are metal, galvanized inside and out and then coated with the 0.8 mm thick outside thermoplastic coating thereof. As for the connection elements, they come in the form of conformed wall-shaped metal parts and they include a zinc coating applied as finishing, which provides a pleasant appearance, a corrosion free guarantee even in severe environment and a great shock resistance. Such rigid mechanical connection parts come within an envelope having, in a typical embodiment, a length of order a few tens of centimeters, a width of order 3 to 4 cm and a height of order 1½ cm and they have a mass of order 65 g.

The patent EP 2,123,578 describes an anchoring part which is a fixed mechanical connection part of the type according to the previously identified second embodiment, intended to be received and supported by a profile and to support a roller track wherein the functional set is here a support, handling, logistic, distribution or storage system comprising a system of roller tracks wherein the fixed mechanical connection is provided by a solid application of the profile on the underlying connection part, by the weight thereof, and of the connection part on the underlying profile by the weight thereof. The attachment part is rigid and comprises a part for receiving a free end part of a first open support gutter-shaped profile which is part of the roller tracks, having a U cradle shape, and a part for attachment to the second profile such as a tube, extending the U-shaped cradle of the receiving part, shaped according to the shape of the second profile so as to be able to be applied on top. Depending on the case, the attachment part comes in the form of a median attachment tab or in the form of two lateral attachment tabs separated by a free median space, which makes it possible to place the median attachment tab of an attachment part associated with the roller track in the free median space of another attachment part associated with another roller tray, wherein the two roller trays can then be placed in the extension of each the other.

As before, an attachment part according to the document EP 2,123,578 previously cited is known to have been made and sold by TRILOGIQ. Such a part is in metal and coated with a zinc based anti-corrosion treatment, providing durability and aesthetics.

The application WO 2006/078087 does not contribute anything more than the patents FR 2,779,782 and EP 1,795,766 previously cited.

Although the fixed mechanical connection parts and the fixed mechanical connection sets previously described, fruits of innovation and successive improvements, can be considered as finished, and prove satisfactory, the inventor selected the problem of improving the technical properties of solidity, usefulness for multiple purposes (different uses, ease of disassembly and reuse), durability, ease of assembly and light weight for transport. Furthermore, in the case of the attachment part according to patent EP 2,123,478, which is held in place by weight, there is a risk of sliding if the attachment part is not additionally blocked from moving relative to the open U profile on the one hand and to the tube on the other.

The state of the prior art is also illustrated by the application JP 2000 283123. Here, it can be seen that the connection set comprising two subordinate fixed mechanical connection parts face-to-face and the means for tightening them to each other is such that there is a significant visible gap between the two parts towards the first profile. This gap is bothersome, unsightly for letting the profile be seen, constitutes a dirt trap and forms a projection which could catch.

The state of the prior art is also illustrated by the application DE 20 2007 001 480. Here, it is seen that the subordinate fixed mechanical connection parts have complex shapes with outside projections for rigidity and a means of tightening comprising no less than four bolts per pair of connection parts. The disadvantages of this embodiment are high weight, dirt traps, projections which could catch and difficult assembly.

The state of the prior art is also illustrated by the application U.S. Pat. No. 2004 0101354. Here, it can be seen that the subordinate fixed mechanical connection parts also have a complex shape with a projecting bolt head, unsightly hollow parts, and a large visible gap between the two parts.

The state of the prior art is also illustrated by the patent U.S. Pat. No. 6,565,279. Here, it can be seen that the subordinate fixed mechanical connection parts are of a different design in that the means of tightening includes two bolts traversing not only the connection parts, but also the profiles themselves. The disadvantages of this embodiment are complexity, high weight, projections which could catch, difficult assembly and poor aesthetics.

In a different technical domain, the patent U.S. Pat. No. 6,343,891 could also be cited; it describes a connection system with two subordinate fixed mechanical connection parts that could not be applied in the technical field of the invention as it was previously defined.

The base problem of the invention is therefore, in the technical domain of the invention as it was previously defined, to propose a fixed mechanical connection part (subordinate or autonomous), or else a fixed mechanical connection set or else an assembly, as previously defined, which both keeps the advantages of the elements described in the patents FR 2,779,782, EP 1,795,766, EP 2,123,919 and EP 2,123,578 and has technical properties at least equal and even superior, in terms of solidity, usefulness for multiple purposes (different uses, ease of disassembly and reuse), durability, ease of assembly and light weight for transport and which also does not have the disadvantages of the elements described in the documents JP 2000 283123, DE 20 2007 001,480, US 2004 0,101,354 and U.S. Pat. No. 6,565,279, like for example the need for projections having to bite a coating with which the profiles are provided and therefore the wear on the profiles, the existence of a visible gap between two subordinate fixed mechanical connection parts, an unsightly appearance, dirt traps, projections which could catch, complex shapes, weight, a complex means of tightening, difficult assembly, the need to drill the profiles, etc.

A description of the invention as it is characterized follows.

According to a first aspect, the subject matter of the invention is a fixed mechanical connection part, intended to fixedly, if necessary removably, mechanically connect a first and a second rigid profile, which:
comprises a first cradle including a first wall whose inner side is suited to receive, engage and come in contact with the outer side of a longitudinal segment of the first profile;
comprises a second cradle including a second wall whose inner side is suited to receive, engage and come in contact with the outer side of a longitudinal segment of the second profile;
comprises a fixed link between the first cradle and the second cradle;
is globally rigid;
by means of a cradle/associated profile continuous application force in the direction of the contact between the inner side of the cradle and the outer side of the profile, the cradle and associated profile are fixedly joined and in that way the first profile and the second profile are fixedly assembled to each other

This part is such that:
the first wall, the second wall, of the first cradle, of the second cradle, is composite and comprises, superposed in a united whole:
   an outer layer shaped part, towards the outer side of the first cradle, of the second cradle, having a high rigidity and a high resistance comparable to that of a rigid and resistant steel, limited on one side by the outer side of the fixed mechanical connection part and limited from the other side by a rigidly uniting interface with an inner layer shaped part; and
   said part with inner layer shape, limited on one side by a rigidly uniting interface with the rigidly uniting interface of the outer layer and limited on the other side by the inner side of the first cradle, of the second cradle, in thermoplastic polyurethane or similar, having a good resistance and some elastic flexibility;
by means of said application force, the inner side of the first cradle, of the second cradle, is applied intimately on the outer side of the first profile/second profile, in the manner of a suction cup, in that way participating in the fixed mechanical connection of the fixed mechanical connection part and the two profiles.

According to an embodiment, the first wall of the first cradle and the second wall of the second cradle comprise, both, an outer layer shaped part, in just one material, and an inner layer shaped part, in just one thermoplastic polyurethane or similar.

According to an embodiment, the entirety of the inner side intended to come into contact with the outer side of the first profile, of the second profile, is, like the inner layer, thermoplastic polyurethane or similar.

According to an embodiment, the wall of the cradle is made by injection of a plastic forming the outer layer and thermoplastic polyurethane or similar forming the inner layer, in particular by bi-injection.

According to an embodiment, the plastic forming the outer layer is a partially aromatic polyamide thermoplastic, in particular reinforced with glass or carbon fibers or similar.

According to a feature, the wall of the cradle has no metal layer.

According to a feature, the inner side of the cradle is uniform and smooth, in particular free of projections for biting into the profile, and has a high sliding-friction.

According to a first possible embodiment, the rigidly uniting interface of the outer layer of the first cradle and/or the second cradle is uniform, without substantial unevenness, and the rigidly uniting interface of the inner layer of the first cradle and/or the second cradle is uniform, without substantial unevenness. According to a second possible embodiment, the rigidly uniting interface of the outer layer of the first cradle and/or the second cradle comprises relief, in particular alternating transverse recesses and projections, and the rigidly uniting interface of the inner layer of the first cradle and/or the second cradle comprises relief, in particular alternating transverse recesses and projections.

According to an embodiment, the inner layer of the first cradle, of the second cradle, is extended by a lateral rim forming extension of the inner layer, which is united at the contact with a longitudinal sidewall of the outer layer of the first cradle, of the second cradle, in particular wherein a longitudinal sidewall of the outer layer of the first cradle, of the second cradle, is substantially completely covered by such an lateral rim forming extension, and wherein such a lateral rim forming extension forms the sidewall of the first cradle, of the second cradle.

According to an embodiment, such a lateral rim forming extension of the first cradle, of the second cradle, is extended by a development united at the contact of the outer free face of the outer layer of the first cradle, of the second cradle, in particular on contact of a recessed part arranged in the outer free face of the outer layer of the first cradle, of the second cradle.

According to an embodiment, the outer side of the fixed mechanical connection part, in the area of the first cradle, of the second cradle, is uniform and smooth, in particular without substantial projections and unevenness.

According to an embodiment, the first cradle comprises on the inside a transverse projection or partition near the fixed link, between the first cradle and the second cradle, wherein the first profile extends entirely from just one side of the fixed mechanical connection part.

According to a first possible embodiment, the second cradle extends from one edge to the other edge of the fixed mechanical connection part by traversing it straight through, wherein the fixed mechanical connection part is suited to be connected to just one second profile extending wholly from just one side or from both sides of the fixed mechanical connection part or to be connected to two second profiles each extending the other, where each extends wholly from just one side of the fixed mechanical connection part opposite each other.

According to a second possible embodiment, the second cradle extends from one edge to the other edge of the fixed mechanical connection part by traversing it straight through, and on the inside comprises a transverse projection or partition, wherein the fixed mechanical connection part is suited to be connected to just one second profile extending wholly from just one side of the fixed mechanical connection part or to be connected to two second profiles extending each other, wherein each extends wholly from just one side of the fixed mechanical connection part.

According to a third possible embodiment, the second cradle extends over only a part between the two edges of the fixed mechanical connection part without traversing it straight through, where the fixed mechanical connection part is suited to be connected to a second unique profile wholly extending from just one side of the fixed mechanical connection part.

According to the embodiments, the first cradle axis of the first cradle, and the second cradle axis of the second cradle are arranged relative to each other transversely, at a right angle or at an inclination, or in parallel, coaxial in a line with each other or transversely separated from each other.

The subject matter of the invention is also, in a first embodiment, a fixed mechanical connection part called “subordinate” such as the one previously described and which, furthermore, is intended to be rigidly combined with a second analogous subordinate fixed mechanical connection part on both sides of the first profile and the second profile, such that the first cradle and the second cradle are turned to the same side of the subordinate mechanical connection part towards an axis orthogonal to the axes of the cradles, for which the longitudinal sidewalls of the first cradle and the second cradle are substantially coplanar or tangent, and which comprise in the fixed link between the cradles a countersunk through hole, suited and intended to allow the assembly of one part of a means of tightening—such as a bolt—from the subordinate fixed mechanical connection part and from the second subordinate fixed mechanical connection part, wherein said through hole extends in a direction substantially orthogonal to the first cradle axis and to the second cradle axis, wherein the two through holes of the subordinate fixed mechanical connection part and the second subordinate fixed mechanical connection part are suited and intended to correspond with each other, wherein for the fixed mechanical connection there is intimate, firm and continuing application, and use of the means of tightening, of the two subordinate connection parts on the outer side of the two profiles.

According to an embodiment of the subordinate fixed mechanical connection part, it comprises just one countersunk through hole arranged in median position.

According to an embodiment of the subordinate fixed mechanical connection part, it comprises a fixed link between the first cradle and the second cradle which extends so as to be adjoining to the first cradle in the axial extension thereof and the proximal longitudinal sidewall of the second cradle, in which is arranged, both the countersunk through hole and also symmetrically relative to the through hole, a positioning projection and a positioning hole extending in the same direction as the axis of the through hole, such that, when the subordinate fixed mechanical connection part and the second subordinate fixed mechanical connection part are combined, the positioning projection of one engages with the positioning hole of the other and vice versa.

According to an embodiment of the subordinate fixed mechanical connection part, it is such that the countersunk through hole is suited to and intended to receive a nut for the means of tightening, and includes, in the hole, a trim of a material having a good resistance and some elastic flexibility, of thermoplastic polyurethane or similar, into which the nut can be pressed down and held during assembly of the tightening means.

According to an embodiment of the subordinate fixed mechanical connection part, the first cradle, the second cradle, and the fixed link between the cradles comprises a lateral rim forming extension of the inner layer, such that when the subordinate fixed mechanical connection part is rigidly combined with the second analogous subordinate fixed mechanical connection part, the two lateral rim forming extensions of the two subordinate fixed mechanical connection parts are in contact with each other or in immediate proximity of each other without a gap, or a substantially visible gap existing between the two subordinate fixed mechanical connection parts.

According to an embodiment of the subordinate fixed mechanical connection part, the outer side of the subordinate fixed mechanical connection part is essentially uniform and smooth, with if necessary the presence of a recessed localized functional area connected with a locking ring. According to an embodiment, this recessed localized functional area forms a locking groove extending from the free transverse sidewall of the first cradle, being suited and intended to engage with a pin of a locking ring.

According to an embodiment of the subordinate fixed mechanical connection part, the width of the first cradle is of the same order of magnitude as the length of the second cradle.

According to an embodiment of the subordinate fixed mechanical connection part, the inner side of the first cradle and/or the inner side of the second cradle has a substantially semicircular shape in transverse perpendicular-section, where the first wall of the first cradle and/or the second wall of the second cradle has a substantially semicircular general shape in transverse perpendicular-section.

In connection with the first embodiment with the subordinate fixed mechanical connection part, the subject matter of the invention is also a fixed mechanical connection set intended to fixedly, if necessary removably, mechanically connect a first profile and a second profile, which includes a first subordinate fixed mechanical connection part and an analogous second subordinate fixed mechanical connection part, such as have been described, and a means of tightening—such as a bolt—of the first subordinate fixed mechanical connection part and of the second subordinate fixed mechanical connection part onto the first profile and onto the second profile.

According to an embodiment of the fixed mechanical connection set, in the case where the first subordinate fixed mechanical connection part and the second subordinate fixed mechanical connection part comprise a locking groove suited and intended to engage with a pin of a locking ring, the fixed mechanical connection set additionally comprises an annular shaped locking ring with at least one radially inward pin, wherein said locking ring is suited and intended to be arranged around the first subordinate fixed mechanical connection part and the second subordinate fixed mechanical connection part, on the side of their first cradles, and around the first profile, so as to engage with friction with the outer side of the two subordinate fixed mechanical connection parts, and wherein a pin is suited and intended to engage with a locking groove.

In connection with the first embodiment with the subordinate fixed mechanical connection part and the fixed mechanical connection set, the subject matter of the invention is also an assembly of profiles including a first profile and a second profile fixedly, if necessary removably, mechanically connected by a fixed mechanical connection set such as was described.

According to an embodiment of this assembly of profiles, the first profile and/or the second profile is a closed profile such as a hollow tube, in particular a reinforced plastic tube with smooth outer side, in particular not having an outer thermoplastic coating which could be locally pressed down.

According to an embodiment of this assembly of profiles, the outer side of the first profile and/or the second profile has a circular shape in transverse perpendicular-section, and the free face forming the inner side of the first cradle and/or the free face forming the inner side of the second cradle has a substantially semicircular shape in transverse perpendicular-section, wherein the first wall of the first cradle and or the second wall of the second cradle has a substantially semicircular general shape in transverse perpendicular-section.

According to a feature of this assembly of profiles, for the fixed mechanical connection, there is intimate, firm and continuing application, and use of the means of tightening for the two subordinate connection parts on the outer side of the two profiles.

The subject matter of the invention is also, in a second embodiment, a fixed mechanical connection part referred to as autonomous such as was previously described (before the description of the subordinate fixed mechanical connection part), wherein the first cradle and the second cradle are turned to one side and to the other of the autonomous fixed mechanical connection part near an axis orthogonal to the axes of the cradles, in which the longitudinal sidewalls of the first cradle and the outer face of the second cradle near the fixed link are substantially coplanar or tangent, and wherein for the fixed mechanical connection, there is intimate, firm and continuing application, and use of the weight of the profile on the underlying cradle and the weight of the cradle and the autonomous fixed mechanical connection part on the underlying profile.

In connection with the second embodiment with the autonomous fixed mechanical connection part, the subject matter of the invention is also an assembly of profiles including a first profile and a second profile fixedly, if necessary removably, mechanically connected by an autonomous fixed mechanical connection assembly such as was described.

According to an embodiment of this assembly of profiles, the first profile is an open profile having a transverse section that is U-shaped or pseudo-U-shaped or comprises a U and the second profile is a closed profile such as a tube, in particular an open profile and a reinforced plastic tube with smooth outer side, in particular not having an outer thermoplastic coating which could be locally pressed down.

According to an embodiment of this assembly of profiles, the outer side of the first profile has a transverse perpendicular section that is U-shaped or pseudo-U-shaped or comprises a U-shape and the inner side of the first profile has a transverse perpendicular section that is U-shaped or pseudo-U-shaped or comprises a U-shape and in which the outer side to the second profile has a transverse perpendicular-section that has a circular shape and the inner side of the second cradle has a transverse perpendicular-section that has a substantially semicircular shape.

According to a feature of this assembly of profiles for the fixed mechanical connection, there is intimate, firm and continuing application, and use of the weight of the profile on the underlying cradle and the weight of the cradle and the autonomous fixed mechanical connection part on the underlying profile.

The subject matter to the invention is also a modular bearing structure comprising a plurality of profiles and one or more fixed mechanical connection parts such as previously described and/or one or more subordinate fixed mechanical connection parts such as previously described and/or one or more fixed mechanical connection sets such as previously described and/or one or more autonomous fixed mechanical connection parts such as previously described arranged for providing a fixed mechanical connection between the profiles, wherein said modular bearing structure is an openwork structure, rigid and is suited and intended for the implementation of functional sets with implementation of Lean Manufacturing, such as shelving, bases (for example for a worksurface), sideboards, devices for conveying, guiding and picking, devices for unloading, carts, wagons and work positions.

The subject matter of the invention is also a functional set for an industrial production or logistic or distribution process with implementation of Lean Manufacturing such as shelving, a base, a sideboard, a device for conveying, guiding and picking, a device for unloading, a cart, a wagon and a work position comprising a modular bearing structure such as previously described and one or more specific additional functional devices such as receptacles, rails, rollers, stops, sliders, wheels and means of driving or moving.

Finally, according to another aspect, the subject matter of the invention is the use of a composite wall which comprises, superposed in one united whole, an outer layer shaped part, towards the outer side, having a high rigidity and a high resistance comparable to that of a rigid and resistant steel, and an inner layer shaped part, in thermoplastic polyurethane or similar, having a good resistance and some elastic flexibility, in order to form a fixed mechanical connection part, a subordinate fixed mechanical connection part, and an autonomous fixed mechanical connection part intended to fixedly, if necessary removably, mechanically connect a first profile and at least one second profile.

The embodiment of the first wall, the second wall, of the first cradle, of the second cradle, of the fixed mechanical connection part, in composite manner with an outer layer shaped part and an inner layer shaped part of thermoplastic polyurethane or similar having a good resistance and some elastic flexibility serves to implement a fixed mechanical connection part having the advantages together with the solidity and durability at least equal to that of the known metal fixed mechanical connection parts described in the patents FR 2,779,782, EP 1,795,766 and EP 2,123,919.

If, as with the known metal fixed mechanical connection parts, the application of the continuous cradle/associated-profile force in the direction of the contact between the inner side of the cradle and the outer side of the profile is called for, for the fixed mechanical connection the means is however different. In these known parts, there is a need to provide the cradles with extended tightening grooves specifically for engaging with the thermoplastic coating of the profiles or with projections specific for locally biting into this coating. The embodiment of these grooves or projections is complex because they must be precise. Additionally, that requires having profiles with an external thermoplastic coating which could be contaminated with dirt. The use of such profiles is complex. After use, the profiles have marks in the area of the anchoring of the projections, which limits or even prevents the reuse of the profiles. Additionally, the projections can break down with use, which also limits or prevents the reuse of the fixed mechanical connection parts. In all cases, the greatest hold is provided very locally in the area of the projections.

With the invention, these disadvantages are resolved. With the inherent advantages, there is no reason to provide anterior grooves or projections. With the inherent advantages, there is no reason to have profiles with an outer thermoplastic coating which could be contaminated. Nothing bites into the profiles which keep their integrity and can be reused. It is the same for the fixed mechanical connection parts. The hold is not provided in a very localized manner but instead is distributed in the manner of a suction cup formed by the inner side of the inner layer of the cradle bearing intimately on the outer side of the profiles because of the embodiment of the inner layer in thermoplastic polyurethane or similar having good resistance and some elastic flexibility, with a smooth inner side. Subsequent to this intimate application, in the manner of a suction cup, the assembly of the mechanical connection parts is easier. For example, the adjustment is easy, could even be continuous, and does not affect the integrity of the parts or even that of the profiles.

With the invention, the assembly of fixed mechanical connection parts becomes easier especially when it involves subordinate parts to the extent where, according to a possible embodiment, the subordinate fixed mechanical connection part is intended to include a countersunk through hole for the nut of the tightening means, and, in the hole, a trim of a material having a good resistance and some elastic flexibility, of thermoplastic polyurethane or similar, into which the nut can be pressed down and held during assembly of the tightening means. Thus, the person who assembles the two subordinate mechanical connection parts is not forced to hold the nut.

With the invention, an unsightly appearance of the assemblies is avoided. In fact, without much difficulty, the mechanical connection parts can have an attractive shape which is hardly possible with shaped metal parts and in wall form. It is also possible to provide that the outer face of the fixed mechanical connection parts be uniform and smooth. Additionally, in the more specific case of subordinate parts, the existence of a gap or substantial visible gap between the two subordinate fixed mechanical connection parts arranged face to face can be avoided.

More generally, the embodiment of the fixed mechanical connection part with an outer layer shaped part and an inner layer shaped part opens the possibility of visual effects such as contrasting colors. Subsequently, with the invention, dirt traps and similarly projections which could catch unexpectedly can be avoided.

In the case of subordinate fixed mechanical connection parts, providing a locking ring is an additional safety factor, which is made possible by providing locking grooves in the parts, which cannot be considered with the known metal fixed mechanical connection parts.

Also, with the invention, it is possible to make fixed mechanical connection parts that are lighter than the known metal ones. For example, instead of a mass of order 65 g, as previously indicated, it is possible to have a mass of order 35 g. This lightness is a significant advantage when it involves parts that need to be shipped.

The figures from the drawings are now briefly described.

FIG. 1 shows the domain of the invention and shows the known functional assembly sets with implementation of Lean Manufacturing.

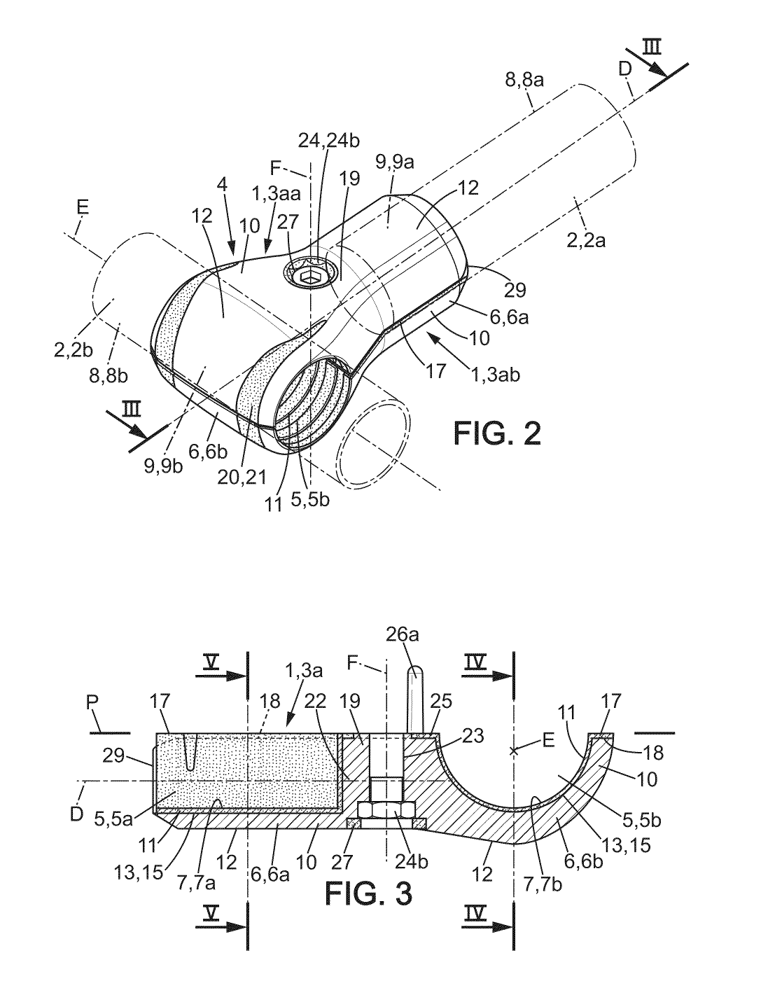

FIG. 2 is a perspective view of an assembly of two profiles (shown in dot-dash lines) with the fixed mechanical connection set comprising two subordinate fixed mechanical connection parts, without the locking ring.

FIG. 3 is a section view of one of the two subordinate fixed mechanical connection parts from FIG. 1, along the section line II-II extending axially relative to the first cradle and transversely relative to the second cradle illustrating, in particular, that the wall of the first, second, cradle, comprises a part with outer layer shape and a part with inner layer shape, respectively towards the outer side and the inner side, that the inner side of the inner layer, inner side of the cradle, is uniform, smooth and free of projections, that the inner layer of the cradles is extended by a lateral rim forming extension, that the first cradle comprises inside a transverse partition towards the fixed link with the second cradle, that the first cradle axis and the second cradle axis are at a right angle, that in the fixed link a single countersunk through hole and a positioning projection are provided, and that a trim in which a nut can be pressed down and held is provided.

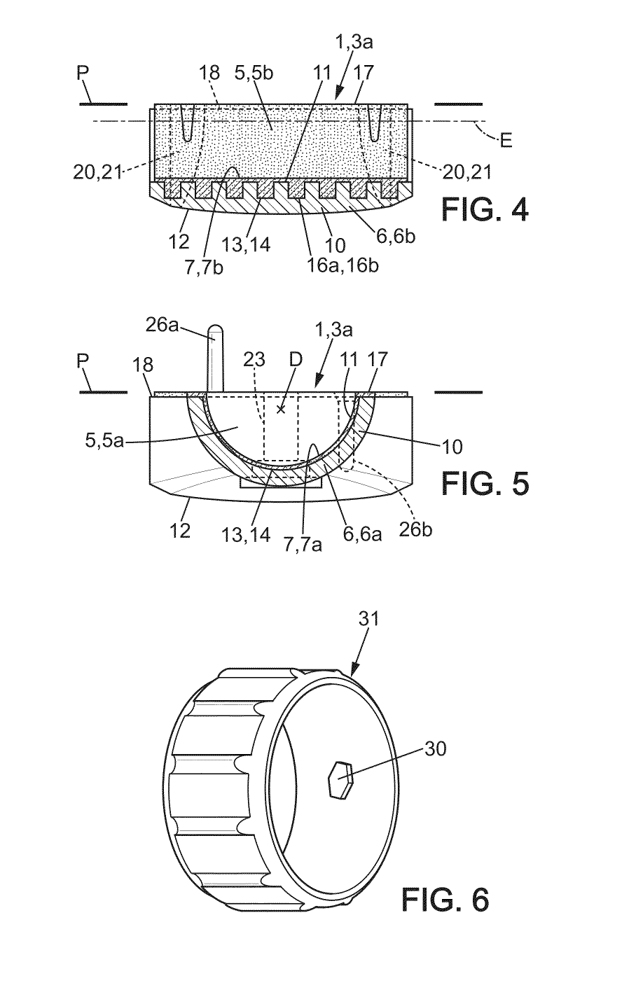

FIGS. 4 and 5 are two section views of the subordinate fixed mechanical connection part from FIG. 3 along the section lines III-III and IV-IV, respectively, illustrating, additionally, in particular, that the rigidly uniting interface of the outer, inner, layer of the first cradle is uniform, that the rigidly uniting interface of the outer, inner, layer of the second cradle comprises alternate transverse recesses and projections, that the inner layer of the cradles is extended by an lateral rim extension forming and that this lateral rim extension forming is extended by a development united at the contact of the outer free face of the outer layer of the second cradle, that the second cradle extends from one edge to the other edge of the fixed mechanical connection part by traversing it straight through, and that in the fixed link, beyond the single countersunk through hole and the positioning projection, a positioning hole is provided.

FIG. 6 is a perspective view of a locking ring showing a pin.

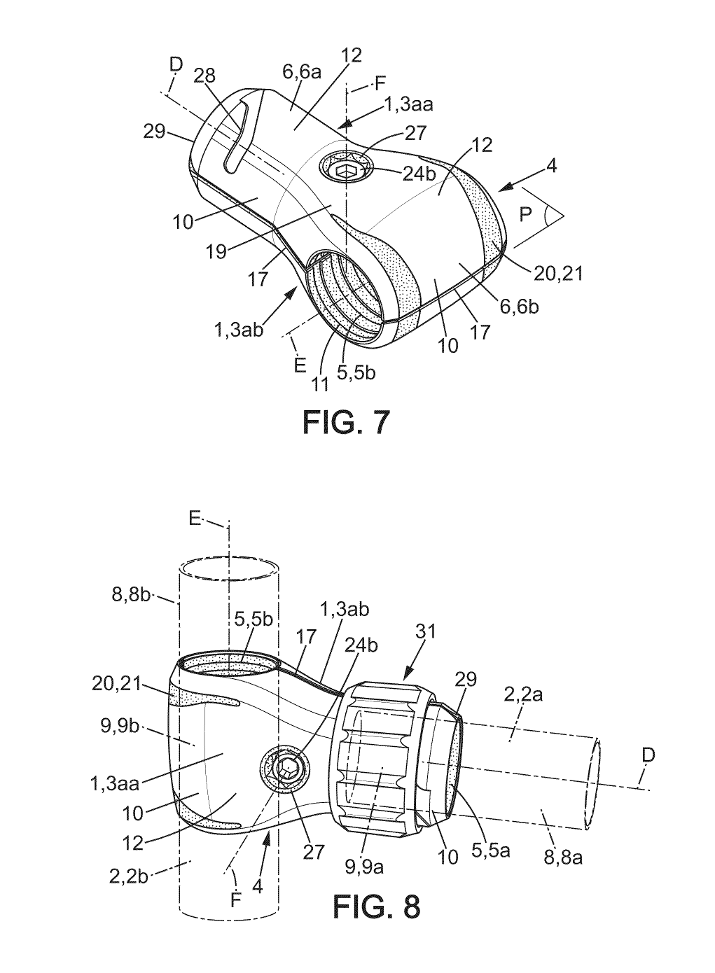

FIG. 7 is a perspective view of two subordinate fixed mechanical connection parts, showing a locking groove.

FIG. 8 is a perspective view of the assembly from FIG. 2 with the locking ring.

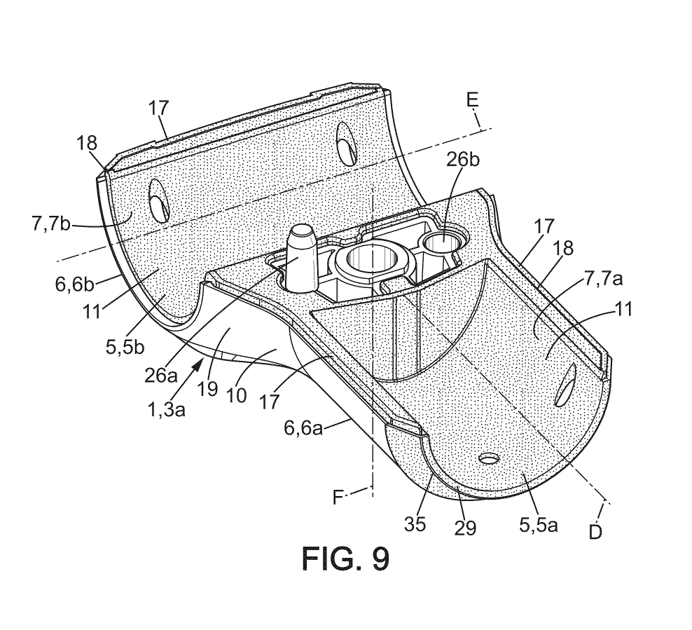

FIG. 9 is a perspective view of a variant of the subordinate fixed mechanical connection part such as previously shown, for which the first composite wall comprises an inner layer shaped part which includes an extension forming the distal transverse sidewall of the first end of the part.

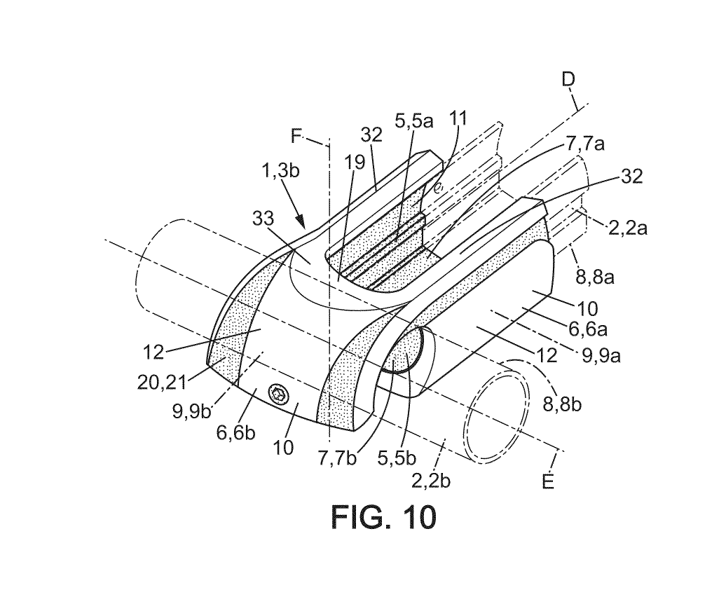

FIG. 10 is a front perspective view of an assembly of two profiles (shown in dot-dash lines) with an autonomous fixed mechanical connection part.

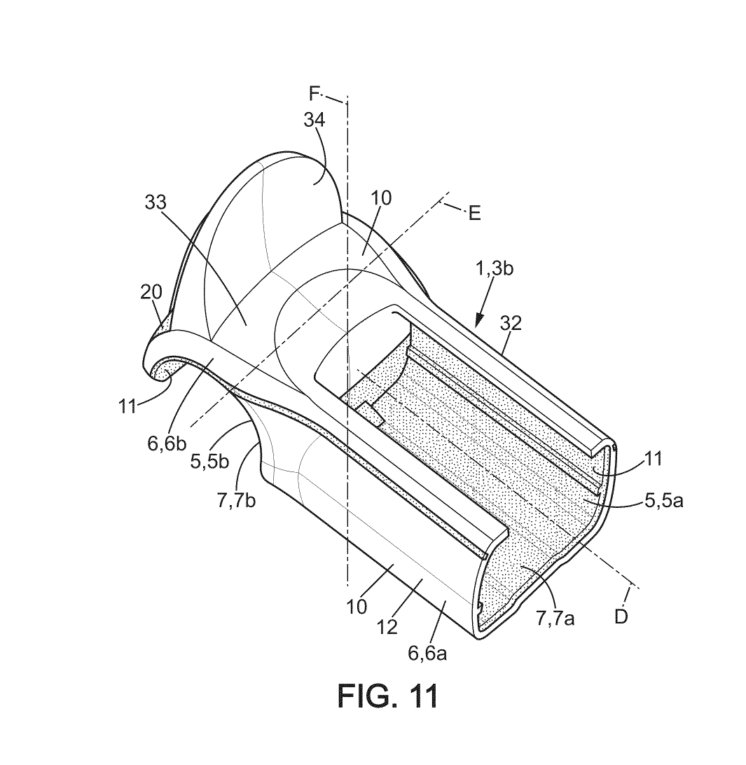

FIG. 11 is a rear perspective view of an autonomous fixed mechanical connection part according to a variant with a projection.

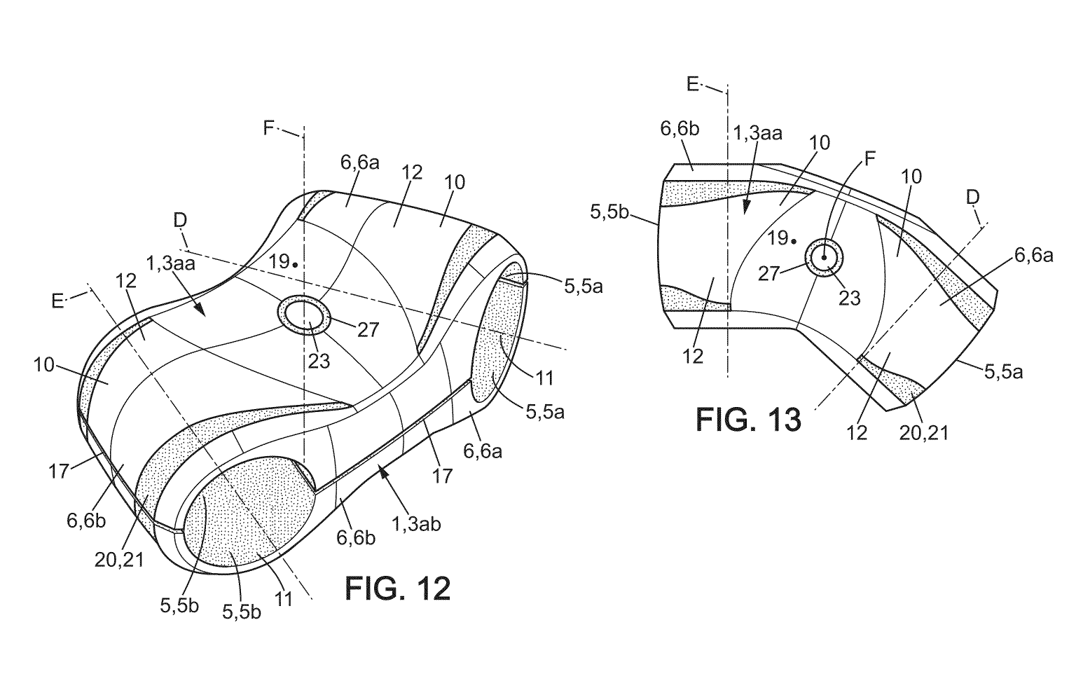

FIGS. 12 and 13 are two views, in perspective and top respectively, showing another embodiment of the fixed mechanical connection set comprising two subordinate fixed mechanical connection parts intended to provide a fixed mechanical connection of profiles arranged side by side relative to each other with an inclination between them.

A detailed description of several embodiments of the invention matched with examples and references to the drawings follows. The definitions given earlier apply to this description and are not necessarily repeated.

In the domain of the invention as previously defined, a fixed mechanical connection part 1 is intended to fixedly, if necessary removably, mechanically connect a first rigid profile 2a and a second rigid profile 2b. Embodiments in which a fixed mechanical part 1 is intended to fixedly, mechanically connect more than two profiles enter into the scope of the invention.

When the intent is to designate a profile generically, the reference number 2 is used.

In a first embodiment (FIGS. 2 to 5 and 7 to 9), the fixed mechanical connection part 1 is a fixed mechanical connection part referred to as subordinate 3a. Such a part is described as “subordinate” because it works with another analogous part: a first such subordinate fixed mechanical connection part 3aa is intended to be combined with a second such analogous connection part 3ab, wherein the two parts 3aa and 3ab belong to a fixed mechanical connection set 4.

In a second embodiment (FIGS. 10 and 11), the fixed mechanical connection part 1 is a fixed mechanical connection part referred to as autonomous 3b. Such a part is described as “autonomous” because it works alone.

A subordinate fixed mechanical connection part 3a and an autonomous fixed mechanical connection part 3b comprise a number of shared features. In the generality thereof, a fixed mechanical connection part is matched with numeric referenced 1, wherein the features thereof are in principle applicable to the subordinate 3a and autonomous 3b fixed mechanical connection parts.

The fixed mechanical connection part 1 first comprises a first cradle 5a having a first axis D and including a first wall 6a for which the inner side 7a is suited to receive, engage and come into contact with the outer side 8a of a longitudinal segment 9a of the first profile 2a. In the embodiment from FIGS. 2 to 5 and 7 to 11, this longitudinal segment 9a of the first profile 2a is an end segment. In the embodiment from FIGS. 12 and 13, this longitudinal segment 9a of the first profile 2a is or is not an end segment.

The fixed mechanical connection part 1 next comprises a second cradle 5b having a second axis E and including a first wall 6b for which the inner side 7b is suited to receive, engage and come into contact with the outer side 8b of a longitudinal segment 9b of the second profile 2b. In the embodiment from FIGS. 2 to 5 and 7 to 13, this longitudinal segment 9b of the second profile 2b can be a segment other than an end segment and typically is not an end segment.

When the intent is to designate a cradle generically, the numeric reference 5 is used. Similarly, the numeric reference 6 is used for a wall, numeric reference 7 for the inner side and numeric reference 8 for the outer side.

The profile 2 can be made of reinforced plastic, have a smooth outer side 8 and be free of an outer thermoplastic coating which can be locally pressed down as is known from the state of the prior technical art. As described, the fixed mechanical connection of the profiles 2 with each other is done only by the outer sides 8 thereof. Also, it is not necessary to provide that one or the other of the profiles 2 be specially laid out in the portion thereof where it is combined with the fixed mechanical connection part 1. For example, it is not necessary to provide that one of the other of the profiles 2 have a slot or hole for a tightening member such as a bolt to pass.

The fixed mechanical connection part 1 also comprises a fixed link 19 between the first cradle 5a and the second cradle 5b. The expression “fixed link” must be understood as designating a part of the fixed mechanical connection part 1 structurally more or less distinct from the cradles 5a, 5b, which connects the cradles 5a, 5b such that they form together and with the fixed link 19 an overall rigid part, wherein the cradles 5a, 5b have a fixed position relative to each other.

With such a fixed mechanical connection part 1, the cradle 5 and the associated profile 2 are fixedly joined by means of a cradle 5/associated profile 2 continuous application force in the direction of contact between the inner side 7 of the cradle 5 and the outer side 8 of the associated profile 2. This is the way in which the first profile 2a and the second profile 2b are assembled fixedly with each other.

According to the invention, the wall 6 of the cradle 5 is composite and comprises, superposed in one united whole, an outer layer shaped part 10 and an inner layer shaped part 11. For brevity, the outer layer shaped part 10 is called “outer layer” 10 and the inner layer shaped part 11 is called “inner layer” 11. In the embodiment shown, this constructive arrangement is found in both the first cradle 5a and in the second cradle 5b.

The term “superposed” must be understood as meaning that the two parts 10 and 11 are placed one over the other and the expression “united whole” as meaning that the two parts 10 and 11 are indissociable once formed.

The term “layer” must be understood as meaning that the parts 10 and 11 have a face range—which in this case is not flat—and a relatively small thickness—which also in this case is not constant—compared to the face range.

The term “inside”, “inner” and the term “outside”, “outer” have to be understood in relation with what, in the profile assembly, is located, respectively, towards the inside—meaning nearer or turned towards the profiles 2—and towards the outside—meaning remote, separated, away from or turned opposite profiles 2.

The outer layer 10 is located near the outer side or outside free face 12 of the cradle 5 and of the fixed mechanical connection part 1. It is limited, towards the outside by this outer side, free outside face 12, and, towards the inside by a rigidly uniting interface 13 with the inner layer 11.

The inner layer 11 is located towards the inner side or inner free face 7, of the cradle 5 and the fixed mechanical connection part 1. It is limited, on one side (towards the inside) by this inner side, free inside face 7, and, on the other side (towards the inside) by a rigidly uniting interface 15 with the outer layer 10.

The outer layer 10 has a high rigidity and a high resistance comparable to that of a rigid and resistant steel and is therefore deformation resistant. It can be made of a plastic which is a partially aromatic polyamide thermoplastic, in particular reinforced with glass, carbon or similar fibers.

The inner layer 11 is of thermoplastic polyurethane or similar, which has a good resistance and some, but limited, elastic flexibility. In order to illustrate the small degree of flexibility, it can be stated that a strong application of the finger on the inner side, inner free side 7, of the inner layer 11 is insufficient to deform it, wherein as a strong application with a pointed tool (such as screwdriver) leads to a local deformation, in this case a depression, limited to the area where the pointed tool was applied. Additionally, this local deformation, depression, is elastic, with the inner side, inner free face 7, returning to the initial shape thereof once application of the pointed tool has stopped. In that way, once the assembly of the profiles is done, the inner layer 11 is not, or substantially not, or only very slightly compressed. Additionally, the inner side, free inner face 7, is uniform and smooth. In particular, it is free of projections known from the prior state-of-the-art. Additionally, it has a high sliding friction compared to the outer side 8 of the profiles 2. The function of the flexibility of the inner layer 11 is essentially to make it such that during the embodiment of the assembly of profiles by respective application fixed mechanical connection part 1/profile 2, the inner side, inner free face 7, of the inner layer 11 perfectly and intimately marries the outer side 8 of the profile 2 involved. The effect of the flexibility of the inner layer 11 is therefore not a substantial compacting of the inner layer 11, as would be the case, for example, with a compressible plastic joint whose thickness could be significantly reduced once even a limited pressure is exerted thereon.

Additionally, according to an embodiment, the wall 6 of the cradle 5 might not, respectively does not, have a rigid metal layer.

The rigidly uniting interface 13 of the outer layer 10 and the rigidly uniting interface 15 of the inner layer 11 are united so as to be fixed and indissociable.

In order to get such a structure, the wall 6 and the fixed mechanical connection part 1 can be made by injection of a plastic forming the outer layer 10 and of thermoplastic polyurethane or similar forming the inner layer 11, in particular by biinjection.

With such an embodiment, the previously mentioned cradle 5/associated profile 2 continuous application force is such that the inner side, free inner face 7, of the cradle 5 is intimately applied onto the outer side 8 of the associated profile 2, in the manner of a suction cup, which in that way participates in the fixed mechanical connection of the fixed mechanical connection part 1 and the two profiles 2.

By “in the manner of a suction cup” applied to the inner side, inner free face 7, of the cradle 5 and the outer side 8 of the associated profile 2, it must be understood that the inner layer 11, without being strictly speaking a suction cup, acts in a way that is similar to that of a suction cup in the sense that following the intimate application of the inner side, inner free face 7—which is uniform and smooth—onto the outer side 8, the first (inner side, inner free face 7) tends to be adhered, or adhere, to the second (outer side 8), since the air between them tends to be expelled or is expelled, and does so because of the certain flexibility of the inner layer 11, the rigidity of the profile 2 and whereas it is possible that the entirety of the inner side, inner free face 7, intended to be applied onto and in contact with the outer side 8 is, like the inner layer, in thermoplastic polyurethane or similar. This embodiment is therefore completely different from that known from the state-of-the-art, where the inner side, inner free face, comprises projections biting into a thermoplastic coating which is provided on the profile.

In the embodiment shown in FIGS. 2 to 5, the rigidly uniting interface 13 of the outer layer 10 of the first cradle 5a is uniform, without substantial unevenness, and, similarly, the rigidly uniting interface 15 of the inner layer 11 of the first cradle 5a is uniform, without substantial unevenness.

In this same embodiment, the rigidly uniting interface 13 of the outer layer 10 of the second cradle 5b comprises reliefs 16a, in particular transverse (relative to the axis E) alternating recesses and projections, and the rigidly uniting interface 15 of the inner layer 11 of the second cradle 5b comprises reliefs 16b, in particular transverse (relative to the axis E) alternating recesses and projections, wherein the reliefs 16a and 16b are complementary. This constructive disposition provides a stronger uniting between the two layers 10 and 11.

According to an embodiment specially illustrated by FIGS. 3 to 7 and 9, the inner layer 11 of the cradle 5 is extended by an extension 17 forming a fairly thin lateral rim directed opposite the axis D, E. This lateral rim forming extension 17 is united at the contact with a longitudinal sidewall 18 of the outer layer 10 of the cradle 5. “Fairly thin” must be understood to mean the thickness of the lateral rim forming extension 17 is, as a relative value, a fraction—for example of order 20%—of the thickness of the wall 6, and, as an absolute value, of order 1 mm. In the embodiment shown, which does not exclude others, the longitudinal sidewall 18 of the outer layer 10 of the cradle 5 is substantially entirely covered by a lateral rim forming extension 17. With such an embodiment, the lateral rim forming extension 17 forms the sidewall of the cradle 5.

Additionally, in an embodiment, the lateral rim forming extension 17 is provided both for the first cradle 5a and also for the second cradle 5b as well as for the fixed link 19. In this case, and for a subordinate fixed mechanical connection part 3aa, this lateral rim forming extension 17 is found on the entirety of the subordinate fixed mechanical connection part 3aa that is located in the plane of the joint P with an analogous second subordinate fixed mechanical connection part 3ab. This lateral rim forming extension 17 then forms the joint area of the two subordinate fixed mechanical connection parts 3aa and 3ab. Thus, when a first subordinate fixed mechanical connection part 3aa is rigidly combined to an analogous second subordinate fixed mechanical connection part 3ab, the two lateral rim forming extensions 17 of the two subordinate fixed mechanical connection parts 3aa and 3ab can be in contact with each other or an immediate proximity with each other, such that no gap, or nearly no gap, exists between the two subordinate fixed mechanical connection parts 3aa and 3ab.

The lateral rim forming extension 17 of the inner layer 11 of the cradle 5 can be extended by a development 20 of the material that makes up the inner layer 11, where the development 20 of the material from the inner layer 11 is united at the contact with the outer side, outer free face 12, of the outer layer 10 of the cradle 5. In the embodiment shown, the development 20 of material from the inner layer 11 is provided on the second cradle 5b. In these embodiments, this development 20 takes the form of two strips extending transversely on the second cradle 5b. Also in these embodiments, the development 20 of material from the inner layer 11 is united at the contact and fills in a recessed part 21 arranged in the outer side, outer free face 12, of the outer layer 10 of the cradle 5. What was specifically described for the second cradle 5b can be transposed to the first cradle 5a.

Providing such a recessed part 21 and providing that the extension 20 of the material of the inner layer 11 fills in the recessed part 21 allows the outer side, outer free face 12, of the fixed mechanical connection part 1, near the cradle 5, to be uniform and smooth, in particular free of substantial projections and unevenness, with the inherent advantages.

According to an embodiment specifically shown in FIG. 9, the inner layer 11 of the first cradle 5a is extended to the other side of the first cradle 5a by an extension 35 directed outward transversely to the axis D. This extension 35 forms the distal transverse sidewall 29 of the first end of the subordinate fixed mechanical connection part 3a. With such an arrangement, deterioration of the inner layer 11 or its combination with the outer layer 10 by axial sliding along the axis D is prevented in this area during placement of a first profile 2a in the two cradles 5a opposite a set 4 of two subordinate fixed mechanical connection parts 3a.

Now referring more specifically to FIG. 3 which shows, in the case of a subordinate fixed mechanical connection part 3a, that the first cradle 5a comprises on the inside a transverse projection or partition 22 located near the fixed link 19. The first profile 2a, which fully extends from just one side of the subordinate fixed mechanical connection part 3a opposite to the second cradle 5b) can come to a stop against this transverse projection or partition 22, if necessary. What was described more specifically for a subordinate fixed mechanical connection part 3a can be transposed to an autonomous fixed mechanical connection part 3b.

Now more specially with reference to FIGS. 4 and 9 which show, in the case of a subordinate fixed mechanical connection part 3a, that the second cradle 5b extends from one edge to the other edge of the subordinate fixed mechanical connection part 3a by traversing it straight through. With such an embodiment, the subordinate fixed mechanical connection part 3a is suited to be connected to a second single profile 2b extending from both sides of the subordinate mechanical connection part 3a. But this embodiment also allows a connection with the second profile 2b extending entirely from just one side of the subordinate mechanical connection part 3a. It also allows connection with two second profiles to be arranged in line with each other, each extending entirely from one side of the subordinate fixed mechanical connection part 3a opposite from the other one. What was described more specifically for a subordinate fixed mechanical connection part 3a can be transposed to an autonomous fixed mechanical connection part 3b.

In another embodiment, not shown, the second cradle 5b extends from one edge to the other of the fixed mechanical connection part 1 by traversing it straight through, but it does comprise a transverse projection or partition on the inside. In this case, the subordinate fixed mechanical connection part 3a is suited either to be connected to a second profile 2b fully extending only from just one side of the subordinate fixed mechanical connection part 3a or to be connected to two second profiles 2b in line with each other, each fully extending from just one side of the subordinate fixed mechanical connection part 3a. This disposition can be applied both to a subordinate fixed mechanical connection part 3a and to an autonomous fixed mechanical connection part 3b.

In another embodiment, not shown, the second cradle 5b extends only part way between the two edges of the fixed mechanical connection part 1 without traversing it straight through. In this case, the fixed mechanical connection part 1 is suited to be connected to a single second profile extending entirely from just one side of the fixed mechanical connection part 1. This disposition can be applied both to a subordinate fixed mechanical connection part 3a and to an autonomous fixed mechanical connection part 3b.

In the embodiments shown in FIGS. 2 to 5 and 7 to 9, the first axis D and the second axis E are arranged transversely to each other, at a right angle. This embodiment is not limiting, since the axes D and E can also, in other embodiments not shown, be arranged transversely to each other, but with an inclination, or else be arranged in parallel, either coaxially or in line with each other or being spaced transversely from each other, or else being side-by-side with some inclination, as shown in FIGS. 12 and 13.

We now refer more specifically to FIGS. 2 to 5 and 7 to 9 which show a subordinate fixed mechanical connection part 3a, a fixed mechanical connection set 4 comprising two such subordinate fixed mechanical connection parts 3aa and 3ab, and the corresponding assembly of profiles 2a and 2b.

A first subordinate fixed mechanical connection part 3aa is suited and intended to be rigidly combined with a second subordinate fixed mechanical connection part 3ab, similar, on both sides of the profiles 2a and 2b.

With such a subordinate fixed mechanical connection part 3a, the first cradle 5a and the second cradle 5b are turned to the same side of the subordinate fixed mechanical connection part 3a towards an axis F, orthogonal to the axes D and E.

The longitudinal sidewalls of the first cradle 5a and the second cradle 5b, more specially formed by the lateral rim forming extension 17 of the inner layer 11 are substantially coplanar or tangent and define the plane of the joint P.

In the fixed link 19, a countersunk through hole 23 is provided that is suited and intended to allow assembly of the first subordinate fixed mechanical connection part 3aa and the second subordinate fixed mechanical connection part 3aa with of one part of a means of tightening 24—such as a bolt.

The through hole 23 extends along the axis F. In the fixed mechanical connection set 4, the two through holes 23 of the first subordinate fixed mechanical connection part 3aa and the second subordinate fixed mechanical connection part 3ab come into correspondence since the arrangement of the hole 23 on the subordinate fixed mechanical connection part 3a is suited and intended for this purpose.

With such subordinate fixed mechanical connection parts 3aa, 3ab for the fixed mechanical connection, there is intimate, firm and continuing application, and use of the means of tightening 24, for the two subordinate connection parts 3aa, 3ab on the outer side 8 of the two profiles 2a, 2b.

According to an embodiment, the subordinate fixed mechanical connection part 3a comprises a single countersunk through hole 23 arranged in median position.

With such a subordinate fixed mechanical connection part 3a, the fixed link 19 extends so as to be adjoining the first cradle 5a in the axial extension thereof and the proximal longitudinal sidewall 25 of the second cradle 5b.

The countersunk through hole 23 is laid out in this fixed link 19 located in median position. A positioning projection 26a and a positioning hole 26b, extending in the same direction as the axis of the hole, meaning along axis F, are arranged symmetrically relative to the countersunk through hole 23. The arrangement of the positioning projection 26a and the positioning hole 26b on the subordinate fixed mechanical part 3a is such that, when the first subordinate fixed mechanical connection part 3aa and the second subordinate fixed mechanical connection part 3ab are combined, the positioning projection 26a of the one engages with the positioning hole 26b of the other and vice versa.

In an embodiment, the countersunk through hole 23 of the first subordinate fixed mechanical connection part 3aa is suited and intended to receive a nut 24b of the means of tightening 24 and in this hole 23, a trim 27 is provided in a material that has good resistance and some elastic flexibility, such as a thermoplastic polyurethane or similar. In that way, the nut 24b can be pressed down in the trim 27 and held in position thereby during assembly of the means of tightening 24, wherein this screw part 24a of the means of tightening passes through the hole 23 of the second subordinate fixed mechanical connection part 3ab.

It is possible that the outer side, outer free face 12, of the outer layer 10 and of the subordinate fixed mechanical connection part 3a be essentially uniform and smooth with, if necessary, the presence of a recessed localized functional area 28, connected with a locking ring 31. Such a recessed localized functional area 28 that forms a locking groove 28 can be provided on the first cradle 5a and extend from this free transverse sidewall 29 of this first cradle 5a. Such a locking groove 28 forming recessed localized functional area 28 is suited and intended to engage with a pin 30 of a locking ring 31.

In an embodiment, the width of the first cradle 5a is the same order of magnitude as the length of the second cradle 5b wherein the subordinate rigid mechanical connection part 3a can be inscribed in an envelope having, for example, a length of order a few tens of centimeters, a width of order 5 cm and a height of order 2 cm, not including the positioning projection, wherein the subordinate rigid mechanical connection part 3a can have a mass of order 35 g.

In the embodiment shown, the inner side 7a of the first cradle 5a and the inner side 7b of the second cradle 5b have a substantially semicircular shape in transverse perpendicular section, wherein the first wall 6a and the second wall 6b have a substantially semicircular general shape in transverse perpendicular section. However, this embodiment does not exclude others.

The fixed mechanical connection set 4 includes a first subordinate fixed mechanical connection part 3aa and a second similar subordinate fixed mechanical connection part 3ab. It also includes the means of tightening 24 and, when it is provided, the locking ring 31.

This locking ring 31 has an annular shape with at least one inward pin 30. It is suited and intended to be positioned around the first subordinate fixed mechanical connection part 3aa and the second subordinate fixed mechanical connection part 3ab on the side of the first cradles 5a thereof and around the first profile 2a, so as to engage by friction with the outer side, outer free face 12, wherein a pin 30 is suited and intended to engage with a locking groove 28.

Another possible embodiment of the two subordinate fixed mechanical connection parts 3a and a fixed mechanical connection set 4 comprising them is shown in FIGS. 12 and 13. In contrast to the embodiment from FIGS. 2 to 5 and 7 to 9, wherein the first axis D and the second axis E are arranged transversely to each other at a right angle, in the embodiment from FIGS. 12 and 13, the first axis D of the first cradle 5a and the second axis E of the second cradle 5b are arranged side by side with a small inclination of an acute angle that can be of order 10°, wherein this inclination value is not however limiting. With such an embodiment, each subordinate fixed mechanical connection part 3a can be symmetric around the plane passing through the axis F, arranged medianly relative to the axes D and E. Also, contrary to the embodiment from FIGS. 2 to 5 and 7 to 9 wherein the first profile 2a is held by the end longitudinal segment 9a thereof, in the embodiments from FIGS. 12 and 13, the first profile 2a is held in a longitudinal segment 9a which, according to the demands and the embodiments, is an end segment or is a segment other than an end segment.

According to a particular variant of this embodiment, the first axis D of the first cradle 5a and the second axis E of the second cradle 5b are arranged side by side in parallel with no inclination relative to each other.

Subordinate fixed mechanical connection parts 3a according to the various embodiments previously described serve to implement such a fixed mechanical connection set 4 which, with the first profile 2a and the second profile 2b, serve to make an assembly of rigidly connected profiles.

With such an assembly, the first profile 2a and/or the second profile 2b is a closed profile such as a hollow tube, in particular a reinforced plastic tube with smooth outer side, in particular not having an outer thermoplastic coating which could be locally pressed down.

In an embodiment, the outer side 8 of the profiles 2a, 2b has a circular shape in transverse perpendicular section and the inner side 7 of the first cradle 5a and of the second cradle 5b have a substantially semicircular shape in transverse perpendicular section, wherein the first wall 6a and the second wall 6b have a substantially semicircular general shape in transverse perpendicular section. This embodiment does not exclude others.

With such an assembly of profiles, for the fixed mechanical connection, there is intimate, firm and continuing application, and use of the means of tightening 24 for the two subordinate connection parts 3aa, 3ab on the outer side 8 of the two profiles 2a, 2b.

We now refer more specifically to FIGS. 10 and 11 which show an autonomous fixed mechanical connection part 3b and the corresponding assembly of the profiles 2a and 2b.

With such an autonomous fixed mechanical connection part 3b, the first cradle 5a and the second cradle 5b are turned to one side and to the other of the autonomous fixed mechanical connection part 3b near an axis F.

In the embodiment shown in FIG. 10, the longitudinal sidewalls 32 of the first cradle 5a and the outer face 33 of the second cradle near the fixed link 19 are substantially coplanar or tangent.

With an embodiment such as that shown in FIGS. 10 and 11, for the fixed mechanical connection, there is intimate, firm and continuing application and use of the weight of the first profile 2a on the underlying first cradle 5a and by the weight of the second cradle 5b and of the autonomous fixed mechanical connection part 3b on the second underlying profile 2b.

With such an autonomous fixed mechanical connection part 3b, it is possible to make an assembly of profiles comprising a first profile 2a and a second profile 2b fixedly, if necessary removably, mechanically connected by an autonomous mechanical connection part 3b.

In such an assembly, and as shown by FIG. 10, the first profile 2a can be an open profile having a transverse section which is U-shaped or pseudo-U-shaped or comprises a U-shape and the second profile 2b can be a closed profile such as a tube. As before, the open profile 2a and the tube 2b can be made of reinforced plastic with smooth outer side, in particular not having an outer thermoplastic coating which could be locally pressed down.

In an embodiment, the outer side 8 of the second profile 2a has a transverse perpendicular-section that has a U-shaped or pseudo-U-shaped or comprises a U-shape and the inner side 7a of the first cradle 5a has a transverse perpendicular-section that has a U-shaped or pseudo-U-shaped or comprises a U-shape. And the outer side 8 of the second profile 2a has a transverse perpendicular-section that has a circular shape, where the inner side 7b of the second cradle 5b has a transverse perpendicular-section that has a substantially semicircular shape. This embodiment does not exclude others.

With such an embodiment, for the fixed mechanical connection, there is intimate, firm and continuing application and use of the weight of the first profile 2a on the underlying first cradle 5a and by the weight of the second cradle 5b and of the autonomous fixed mechanical connection part 3b on the second underlying profile 2b.

The two autonomous fixed mechanical connection parts 3b from FIGS. 10 and 11 are distinguished from each other by the fact that the one from FIG. 11 has a projection 34 located on the outer face 33 of the second cradle 5b which extends parallel with the axis E over, here, the full axial length of the second cradle 5b. This projection has an outer dimension measured along the axis F which is of order of magnitude of the depth of the second cradle 5B along this axis F.

The invention also covers a modular bearing structure comprising a plurality of profiles 2 and one or more fixed mechanical contact parts 1, one or more subordinate fixed mechanical connection parts 3a, one or more fixed mechanical connection sets 4, and one or more autonomous fixed mechanical connection parts 3b, arranged for providing a fixed mechanical connection between the profiles 2. Such a modular bearing structure is gap free and rigid and it is designed to be suited and intended to making functional assemblies with implementation of Lean Manufacturing.

Such functional sets for an industrial production or logistic or distribution process with use of Lean Manufacturing are for example shelving, bases (for example for a worksurface), sideboards, devices for conveying, guiding and picking, devices for unloading, carts, wagons and work positions. They include a modular bearing structure such as previously mentioned and one or more specific additional functional devices such as receptacles, rails, rollers, stops, sliders, wheels and means of driving or moving. Finally, in another aspect, the invention covers the use of a composite wall 6 which comprises, superposed in one united whole, an outer layer shaped part 10, towards the outer side 12, having a high rigidity and a high resistance comparable to that of a rigid and resistant steel, and an inner layer shaped part 11, in thermoplastic polyurethane or similar, having a good resistance and some elastic flexibility, in order to form a fixed mechanical connection part 1, 3a, 3b intended to fixedly, if necessary removably, mechanically connect a first profile 2a and a second profile 2b.

1. A fixed mechanical connection part intended to fixedly, if necessary removably, mechanically connect a first rigid profile and a second rigid profile, which
comprises a first cradle including a first wall whose inner side is suited to receive, engage and come in contact with the outer side of a longitudinal segment of the first profile;
comprises a second cradle including a second wall whose inner side is suited to receive, engage and come in contact with the outer side of a longitudinal segment of the second profile;
comprises a fixed link between the first cradle and the second cradle;
is globally rigid;
by means of a cradle/associated profile continuous application force in the direction of the contact between the inner side of the cradle and the outer side of the profile, the cradle and associated profile are fixedly joined and in that way the first profile and the second profile are fixedly assembled to each other, wherein
the first wall, the second wall, of the first cradle, of the second cradle, is composite and comprises, superposed in a united whole:
an outer layer shaped part, towards the outer side of the first cradle, of the second cradle, having a high rigidity and a high resistance comparable to that of a rigid and resistant steel, limited on one side by the outer side of the fixed mechanical connection part and limited from the other side by a rigidly uniting interface with an inner layer shaped part; and
said inner layer shaped part, limited on one side by a rigidly uniting interface with the rigidly uniting interface of the outer layer and limited on the other side by the inner side of the first cradle, of the second cradle, in thermoplastic polyurethane or similar, having a good resistance and some elastic flexibility;
by means of said application force, the inner side of the first cradle, of the second cradle, is applied intimately on the outer side of the first profile/second profile, in the manner of a suction cup, in that way participating in the fixed mechanical connection of the fixed mechanical connection part and the two profiles.

2. The fixed mechanical connection part according to claim 1, wherein the first wall of the first cradle and the second wall of the second cradle comprise, both, an outer layer shaped part, in just one material, and an inner layer shaped part, in just one thermoplastic polyurethane or similar.

3. The fixed mechanical connection part according to claim 1, wherein the entirety of the inner side intended to come into contact with the outer side of the first profile, of the second profile, is, like the inner layer, thermoplastic polyurethane or similar.

4. The fixed mechanical connection part according to claim 1, wherein the wall of the cradle is made by injection of a plastic forming the outer layer and thermoplastic polyurethane or similar forming the inner layer, in particular by biinjection.

5. The fixed mechanical connection part according to any one of claim 1, wherein the plastic forming the outer layer is a partially aromatic polyamide thermoplastic, in particular reinforced with glass or carbon fibers or similar.

6. The fixed mechanical connection part according to any one of claim 1, wherein the wall of the cradle has no metal layer.

7. The fixed mechanical connection part according to claim 1, wherein the inner side of the cradle is uniform and smooth, in particular free of projections for biting into the profile, and has a high sliding-friction.

8. The fixed mechanical connection part according to claim 1, wherein the rigidly uniting interface of the outer layer of the first cradle and/or of the second cradle is uniform, without substantial unevenness, and the rigidly uniting interface of the inner layer of the first cradle and/or the second cradle is uniform, without substantial unevenness.

9. The fixed mechanical connection part according to claim 1, wherein the rigidly uniting interface of the outer layer of the first cradle and/or of the second cradle comprises relief, in particular alternating transverse recesses and projections, and the rigidly uniting interface of the inner layer of the first cradle and/or of the second cradle comprises relief, in particular alternating transverse recesses and projections.

10. The fixed mechanical connection part according to claim 1, wherein the inner layer of the first cradle, of the second cradle, is extended by a lateral rim forming extension of the inner layer, which is united at the contact with a longitudinal sidewall of the outer layer of the first cradle, of the second cradle, in particular wherein a longitudinal sidewall of the outer layer of the first cradle, of the second cradle, is substantially completely covered by such a lateral rim forming extension, and wherein such a lateral rim forming extension forms the sidewall of the first cradle, of the second cradle.

11. The fixed mechanical connection part according to claim 10 wherein a lateral rim forming extension of the inner layer of the first cradle, of the second cradle, is extended by a development united at the contact of the outer side of the outer layer of the first cradle, of the second cradle, in particular at the contact of a recessed part arranged in the outer side of the outer layer of the first cradle, of the second cradle.

12. The fixed mechanical connection part according to claim 1, wherein the outer side of the fixed mechanical connection part, in the area of the first cradle, of the second cradle, is uniform and smooth, in particular without substantial projections and unevenness.

13. The fixed mechanical connection part according to claim 1, wherein the first cradle comprises on the inside a transverse projection or partition near the fixed link, between the first cradle and the second cradle, wherein the first profile extends entirely from just one side of the fixed mechanical connection part.

14. The fixed mechanical connection part according to claim 1, wherein the second cradle extends from one edge to the other edge of the fixed mechanical connection part by traversing it straight through, wherein the fixed mechanical connection part is suited to be connected to just one second profile extending wholly from just one side or from both sides of the fixed mechanical connection part or to be connected to two second profiles each extending the other, where each extends wholly from just one side of the fixed mechanical connection part opposite each other.

15. The fixed mechanical connection part according to claim 1, wherein the second cradle extends from one edge to the other edge of the fixed mechanical connection part by traversing it straight through, where the fixed mechanical connection part is suited to be connected to just one second profile extending wholly from just one side or from both sides of the fixed mechanical connection part or to be connected to two second profiles each extending the other, wherein each extends wholly from just one side of the fixed mechanical connection part opposite each other.

16. The fixed mechanical connection part according to claim 1, wherein the second cradle extends over only a part between the two edges of the fixed mechanical connection part without traversing it straight through, wherein the fixed mechanical connection part is suited to be connected to a second unique profile wholly extending from one side of the fixed mechanical connection part.

17. The fixed mechanical connection part according to claim 1, wherein the first cradle axis of the first cradle, and the second cradle axis of the second cradle are arranged relative to each other transversely, at a right angle or at an inclination, or in parallel, coaxial in a line with each other or transversely separated from each other.

18. A subordinate fixed mechanical connection part according to claim 1, intended to be rigidly combined with a second analogous subordinate fixed mechanical connection part on both sides of the first profile and the second profile, such that the first cradle and the second cradle are turned from one same side of the subordinate mechanical connection part towards an axis orthogonal to the axes of the cradles, for which the longitudinal sidewalls of the first cradle and the second cradle are substantially coplanar or tangent, and which comprise in the fixed link between the cradles a countersunk through hole, suited and intended to allow the assembly of one part of a means of tightening—such as a bolt—from the subordinate fixed mechanical connection part and from the second subordinate fixed mechanical connection part, wherein said through hole extends in a direction substantially orthogonal to the first cradle axis and to the second cradle axis, wherein the two through holes of the subordinate fixed mechanical connection part and of the second subordinate fixed mechanical connection part are suited and intended to correspond with each other, wherein for the fixed mechanical connection there is intimate, firm and continuing application, and use of the means of tightening, of the two subordinate connection parts on the outer side of the two profiles.

19. The subordinate fixed mechanical connection part according to 18, comprising just one countersunk through hole arranged in median position.

20. The subordinate fixed mechanical connection part according to one of claim 18, comprising a fixed link between the first cradle and the second cradle which extends so as to be adjoining to the first cradle in the axial extension thereof and the proximal longitudinal sidewall of the second cradle, in which is arranged, both the countersunk through hole and also symmetrically relative to the through hole, a positioning projection and a positioning hole extending in the same direction as the axis of the through hole, such that, when the subordinate fixed mechanical connection part and the second subordinate fixed mechanical connection part are combined, the positioning projection of one engages with the positioning hole of the other and vice versa.

21. The subordinate fixed mechanical connection part according to claim 18, wherein the countersunk through hole is suited to and intended to receive a nut of the means of tightening, that includes, in the hole, a trim of a material having a good resistance and some elastic flexibility, of thermoplastic polyurethane or similar, into which the nut can be pressed down and held during assembly of the tightening means.

22. The subordinate fixed mechanical connection part according to claim 18, wherein the first cradle, the second cradle, and the fixed link between the cradles comprises a lateral rim forming extension of the inner layer, such that when the subordinate fixed mechanical connection part is rigidly combined with the second analogous subordinate fixed mechanical connection part, the two rim forming extensions of the two subordinate fixed mechanical connection parts are in contact with each other or in immediate proximity of each other without a gap, or a substantially visible gap existing between the two subordinate fixed mechanical connection parts.

23. The subordinate fixed mechanical connection part according to claim 18, wherein the outer side of the subordinate fixed mechanical connection part is essentially uniform and smooth, with, if necessary, the presence of a recessed localized functional area connected with a locking ring.

24. The subordinate e fixed mechanical connection part according to claim 18, comprising a recessed localized functional area on the outer side of the subordinate fixed mechanical connection part, on the first cradle, where this recessed localized functional area forms a locking groove extending from the free transverse sidewall of the first cradle, and which is suited and intended to engage with a pin of a locking ring.

25. The subordinate fixed mechanical connection part according to claim 18, wherein the width of the first cradle is of the same order of magnitude as the length of the second cradle.

26. The subordinate fixed mechanical connection part according to claim 18, wherein the inner side of the first cradle and/or the inner side of the second cradle has a substantially semicircular shape in transverse perpendicular-section, where the first wall of the first cradle and/or the second wall of the second cradle has a substantially semicircular general shape in transverse perpendicular-section.

27. A fixed mechanical connection set intended to fixedly, if necessary removably, mechanically connect a first profile and a second profile, which includes a first subordinate fixed mechanical connection part and an analogous second subordinate fixed mechanical connection part, according to claim 18, and a means of tightening—such as a bolt—of the first subordinate fixed mechanical connection part and of the second subordinate fixed mechanical connection part onto the first profile and onto the second profile.

28. The fixed mechanical connection set according to claim 27, in the case where the first subordinate fixed mechanical connection part and the second subordinate fixed mechanical connection part comprise a locking groove suited and intended to engage with a pin of a locking ring, furthermore comprising an annular shaped locking ring with at least one radially inward pin, wherein said locking ring is suited and intended to be arranged around the first subordinate fixed mechanical connection part and the second subordinate fixed mechanical connection part, on the side of their first cradles, and around the first profile, so as to engage with friction with the outer side of the two subordinate fixed mechanical connection parts, and wherein a pin is suited and intended to engage with a locking groove.

29-40. (canceled)
